(19) United States
(12) Patent Application Publication
(10) Pub. No.: US 2015/0208661 A1
(43) Pub. Date: Jul. 30, 2015

(54) METHOD FOR PREPARING BROMINE BASED BIOCIDAL AQUEOUS COMPOSITIONS

(71) Applicant: BROMINE COMPOUNDS LTD., Beerh Sheva, IL (US)

(72) Inventor: Shlomo Antebi, Haifa (IL)

(21) Appl. No.: 14/417,349

(22) PCT Filed: Jul. 30, 2013
(86) PCT No.: PCT/IL2013/050645

§ 371 Date: Jan. 26, 2015

Related U.S. Application Data
(60) Provisional application No. 61/677,534, filed on Jul. 31, 2012.

(51) Int. Cl. A01N 59/00; A01N 25/00

(52) U.S. Cl. CPC A01N 59/00; A01N 25/00

(57) ABSTRACT

The invention provides a biocidal and antifouling composition prepared by combining an aqueous solution consisting of a bromide source and urea with an aqueous solution consisting of an oxidizer; wherein the pH of said composition is at least 13.

### FIELD OF THE INVENTION

The present invention relates to a method of preparing stable biocidal compositions from oxidants and bromide sources, which method efficiently utilizes said oxidants and provides stable compositions for controlling biofouling.

### BACKGROUND OF THE INVENTION

An undesired accumulation of organisms or organic residues in liquid volumes or on wet surfaces is controlled by a variety of methods, including mechanical treatments, modifying water concentration, applying organic and inorganic biocidal materials, changing temperature, etc. There is perpetual demand for new methods, because known methods are not always applicable, and new situations incessantly appear, as well as new or resistant contaminants. Active halogen is popular, frequently in the form of hypochlorite alkali solutions, but it was observed that active bromine is biocidally more efficient than active chlorine. Drawbacks of known methods include losses of active halogen when converting active chlorine to active bromine, low stability of the active species, and difficult handling of numerous reactants necessary for producing the active species on the site of application. It is therefore an object of the invention to provide a method for manufacturing a bromine based biocidal and antifouling composition without the drawbacks of the previous methods.

It is another object of the invention to provide means for achieving very high biocidal effect on the site of need by combining simple precursor solutions.

It is further an object of the invention to provide bromine-containing biocidal and antifouling solutions from active chlorine with low losses of the active species.

Other objects and advantages of present invention will appear as description proceeds.

### SUMMARY OF THE INVENTION

The invention provides a bromine-containing biocidal and antifouling aqueous composition, comprising component A and component B, wherein component A is an aqueous solution consisting of a bromide source, and urea in a molar ratio to said bromide source of between 0.5 and 10, usually between 1 and 5; and component B is an aqueous solution consisting of an oxidizer essentially having the same molar concentration as said bromide source; wherein said components A and B are either separate or mixed, and wherein said components provide a pH of at least 13.0 when combined. In one embodiment, the invention provides a bromine-containing biocidal and antifouling aqueous composition comprising component A and component B, wherein i) component A is an aqueous solution consisting of a bromide source and urea in a molar ratio to said bromide source of between 0.5 and 10, preferably between 1 and 5, said solution having a pH of more than about 4.0, preferably more than about 6.0; and ii) component B is an aqueous solution consisting of an oxidizer essentially having the same molar concentration as said bromide source, said solution having a pH of more than 13.0; wherein said components A and B are either separate or mixed. Said bromide source usually has a concentration of less than 5 mol/l, for example 2 mol/l, and said urea is preferably in a molar ratio to said bromide source of between 1 and 5, often between 1.5 and 5. In some embodiments, said bromide source has a concentration of less than 2 mol/l. In other embodiments, said bromide source has a concentration of 2 mol/l or more. The bromine-containing biocidal and antifouling aqueous composition according to the invention preferably comprises i) component A which is an aqueous solution consisting of a bromide source and urea in a molar ratio to said bromide source of between 1.5 and 5; and ii) component B which is an aqueous solution consisting of an oxidizer having essentially the same molar concentration as said bromide source, and alkali hydroxide in a molar ratio to said oxidizer of between 0.8 and 2.5. Said molar ratio of the alkali hydroxide to said oxidizer may be between 0.8 and 2.0 or between 1 and 2, for example, about 2. In a bromine-containing biocidal and antifouling aqueous composition according to the invention, said component A is an aqueous solution consisting of a bromide source selected from alkaline bromides, and urea in a molar ratio to said bromide source of between 1.8 and 3; and component B is an aqueous solution consisting of an oxidizer having essentially the same molar concentration as said bromide source, selected from NaOCl, LiOCl, Ca(OCl)₂, chlorinated isocyanurates, urea hydroperoxide, hydrogen peroxide, percarbonates, perborates, peracetates or peroxycarboxylic acids, and persulfates, said biocidal and antifouling composition comprising an alkali hydroxide in a molar ratio to said oxidizer of between 0.8 and 2.5, wherein said hydroxide is at least partially premixed with said component A and/or with said component B, or it is divided between components A and B, and wherein said components A and B are either separate or mixed. In a preferred embodiment of the invention, said component A is an aqueous solution consisting of sodium bromide (NaBr) in a concentration of less than 5 mol/l, for example between 0.05 mol/l and 2 mol/l, and urea in a molar ratio to said sodium bromide of between 1.8 and 3; and said component B is an aqueous solution consisting of sodium hypochlorite (NaOCl) having essentially the same molar concentration as said sodium bromide, and sodium hydroxide (NaOH) in a molar ratio to said oxidizer of between 1 and 2. In one aspect of the invention, said components A and B in the bromine-containing biocidal and antifouling aqueous composition of the invention are mixed, whereas the pH of the mixture is at least 13. In another aspect of the invention, said components A and B in the bromine-containing biocidal and antifouling aqueous composition of the invention are separate and ready to be mixed near the site to be disinfected. Said components A and B may be diluted with water before their mixing or after. In one embodiment, a bromine-containing biocidal and antifouling aqueous composition is obtained by mixing component A and component B essentially having the same volumes, wherein component A is an aqueous solution consisting of a bromide source in a concentration usually between 0.05 and 5 mol/l, for example of less than 2 mol/l, and urea in a molar ratio to said bromide source of between 1.5 and 5, said solution having a pH of more than 6.0; and component B is an aqueous solution consisting of an oxidizer essentially having the same molar concentration as said bromide source, said solution having a pH of more than 13.0; wherein the yield of active halogen after said mixing is at least 70% relatively to the initial amount of the oxidizer, when measured by iodometric titration. In a preferred embodiment of the invention, said components A and B form two liquid streams to be combined near the site to be disinfected. In one embodiment, i) component A is an aqueous solution consisting of NaBr in a concentration of less than 2 mol/l, such as up to 1 mol/l or up to 0.5 mol/l, and urea in a molar ratio to said bromide source of between 1.5 and 2; ii) component B is an aqueous solution consisting of NaOCl having essentially the same molar concentration as said NaBr, and NaOH in a molar ratio to said oxidizer of between 1.5 and 2.5, such as about 2; wherein said components A and B are either separate or mixed. The terms “about” in regard to the amounts of the components in the instant compositions, as well as the term “essentially the same”, means within 20% difference, preferably within 10% difference. In one embodiment said components A and B have essentially the same volumes. In other embodiment, i) component A is an aqueous solution consisting of NaBr, and urea in a molar ratio to said bromide source of about 1.8; ii) component B is an aqueous solution consisting of NaOCl having essentially the same molar concentration as said NaBr, and NaOH in a molar ratio to said oxidizer of about 1.8; wherein said components A and B are either separate or mixed. In one embodiment, the bromine-containing biocidal and antifouling aqueous composition according to the invention may comprise component A which is an aqueous solution consisting of a bromide source, urea, and a hydroxide of alkali metal in a molar ratio to said bromide source of between 0.8 and 2.

In an important aspect, the invention is directed to a bromine-containing biocidal aqueous composition obtained by mixing component A and component B essentially having the same volumes, wherein i) component A is an aqueous solution consisting of a bromide source in a concentration of less than 5 mol/l, for example of less than 2 mol/l, and urea in a molar ratio to said bromide source of between 1.5 and 5, said solution having a pH of more than 6.0; and ii) component B is an aqueous solution consisting of an oxidizer essentially having the same molar concentration as said bromide source, said solution having a pH of more than 13.0; wherein the yield of active halogen, including active bromine, is at least 70% relatively to the initial amount of the oxidizer, when measured by iodometric titration; said yield may be at least 75% or at least 80%.

In a preferred embodiment of the invention, said components A and B form two liquid streams, or said components A and B and an aqueous solution of alkali hydroxide form together three liquid streams, said streams being combined near the site to be disinfected. In a preferred combination, a bromine-containing biocidal and antifouling aqueous composition according to the invention comprises component A and component B, wherein said component A is an aqueous solution consisting of NaBr in a concentration of less than 2 mol/l and urea in a molar ratio to said bromide source of between 1 and 2, often between 1.5 and 2; component B is an aqueous solution consisting of a) NaOCl having essentially the same molar concentration as said NaBr, and b) NaOH either separate or admixed with said NaOCl in a molar ratio to said NaOCl of between 1.5 and 2.5; and wherein said components A and B have the same volumes and are either separate or mixed.

The invention is directed to the above composition for use in water disinfection, in removing or preventing biofouling either in a volume of an aqueous phase or on a surface in contact with an aqueous phase, wherein said components A and component B are combined and then a) either mixed with said volume of an aqueous phase or b) contacted with said surface. Said composition is, in one preferred embodiment, a two-component composition comprising component A and component B, wherein said components are transported near to the site where said biofouling is to be prevented or removed, and then the components are applied either before diluting with water or after. The composition is either a two-component composition comprising component A and component B, or a three-component system comprising said components A and B, and further NaOH in aqueous solution, wherein said components are transported near to the site where said biofouling is to be prevented or removed, and then the components are applied either before diluting with water or after.

The invention provides a kit for removing or preventing biofouling either in a volume of an aqueous phase or on a surface in contact with an aqueous phase, comprising said two-component composition.

The invention relates to a process of removing or preventing biofouling in a volume of an aqueous phase or on a surface in contact with an aqueous phase, comprising i) providing a bromine-containing biocidal and antifouling aqueous composition containing said components A and B; and ii) contacting said liquid phase or said surface with said composition. The process according to the invention may comprise steps of i) optionally diluting one or both of said components A and B; and ii) forming two liquid streams, one comprising said component A and the other said component B, and combining said two streams near said volume of a liquid phase or near said surface, or in said volume or on said surface. The process according to the invention may, in one embodiment, comprise i) mixing said components A and B; ii) optionally diluting one or both of said components A and B before said mixing of step i), or alternatively diluting the mixture of components A and B obtained in step i); and iii) forming a liquid stream near said volume of a liquid phase or near said surface. Said aqueous phase may have a high TOC content. Said aqueous phase or said surface may comprise irrigation pipes, waste water, industrial cooling water, process water, and equipment in the Pulp & Paper industry. Said antifouling composition may unclog pierced irrigation pipes and fertilizes the irrigated plot. Said step of providing the antifouling or biocidal and antifouling composition in the process of the invention may be a batch procedure or a continuous procedure. The bromine-containing biocidal and antifouling aqueous composition of the invention may exhibit biocidal and antifouling activity even when diluted down to an active bromine concentration of 0.1 ppm. Said process of removing or preventing biofouling in a volume of an aqueous phase or on a surface in contact with the aqueous phase preferably comprises i) providing component A consisting of an aqueous solution of NaBr and urea in a weight ratio of about 1:1; ii) providing component B consisting of an aqueous solution of NaOCl and NaOH in a weight ratio of about 1:1, wherein the weight ratio of urea/NaOH is about at least 1.2, for example about 1.4; iii) combining equal volumes of said components A and B, optionally before or after the dilution with water; and iv) contacting said liquid phase or said surface with said composition comprising said components A and B. Said components A and B, one or both, may be diluted with water before contacting each other or after, and said components may comprise NaOH. Said components A and B may form either two liquid streams or together with a solution of alkali hydroxide three liquid streams, wherein said streams may be combined near said volume of a liquid phase or near said surface, or in said volume or on said surface to be treated. In a particularly preferred embodiment, said component A will be a stable mixture of urea and sodium bromide, to be safely stored and transported to the site of application. In another preferred embodiment, component A, aqueous NaOCl, and NaOH will be separately stored and transported to the site of application. In still another preferred embodiment, component A, component B, and optionally NaOH will be separately provided and used near the site of application, said NaOH being either solid or dissolved in water.

The invention is directed to a method of cleaning, and/or a method of disinfecting, and/or a method of preventing/removing biofilm accumulation, in industrial and agricultural equipments, comprising contacting the surfaces or volumes to be cleaned with an aqueous composition containing active bromine species and high alkalinity. Said surfaces may comprise, in one embodiment, surfaces of food items, for example meat. In other embodiment, said surfaces may comprise surfaces for preparing packaging materials, particularly food packaging materials.

The process of the invention for removing or preventing biofouling in a volume of an aqueous phase or on a surface in contact with an aqueous phase, preferably comprises i) providing component A and component B; wherein component A is an aqueous solution consisting of a bromide source in a concentration of less than 5 mol/l, for example less than 2 mol/l, such as from 0.1 to 1.5 mol/l or from 0.2 to 1 mol/l, and urea in a molar ratio to said bromide source of between 1.5 and 5, said solution having a pH of more than 6.0; and component B is an aqueous solution consisting of an oxidizer essentially having the same molar concentration as said bromide source, said solution having a pH of more than 13.0; and ii) contacting said volume or surface with said composition; wherein said components A and B are either separate or mixed when contacting said volume or surface to be treated against biofouling. Said aqueous phase or said surface may comprise irrigation pipes, waste water, industrial cooling water, process water, equipment in the Pulp & Paper industry, packaging material, and food item such as meat. In a preferred embodiment, said biocidal and antifouling composition unclogs pierced irrigation pipes and fertilizes the irrigated plot. Said step of providing the biocidal and antifouling composition may be a batch procedure or a continuous procedure. In the process of the invention, said bromine-containing biocidal and antifouling aqueous composition may be diluted with water to reach an active bromine concentration of at least 0.1 ppm.

In a preferred embodiment, the invention is directed to process of removing or preventing biofouling in a volume of an aqueous phase or on a surface in contact with an aqueous phase, comprising i) providing a composition consisting of components A and component B, wherein component A contains aqueous urea and NaBr in a molar ratio of about 2:1, and component B contains aqueous NaOH and NaOCl in a molar ratio of about 2:1; and ii) contacting said composition with said volume of the aqueous phase or with said surface before or after mixing said components A and B; wherein the molar ratio of NaBr and NaOCl in mixed components is about 1:1. In one embodiment of the invention, the molar concentrations of the reactants present in the final mixture, urea/NaBr/NaOCl/NaOH, can be approximately expressed as follows: 2/1/1/2. The word “approximately” in this context means within plus/minus 20%, and preferably within ±10%; for example, urea/NaBr are preferably in molar ratio from 1.8:1 to 2.2:1 (which is 2+10%:1).

In another preferred embodiment, the invention is directed to process of removing or preventing biofouling in a volume of an aqueous phase or on a surface in contact with an aqueous phase, comprising i) providing a composition consisting of components A and component B, wherein component A contains aqueous urea and NaBr in a weight ratio of about 1:1, and component B contains aqueous NaOH and NaOCl in a weight ratio of about 1:1; and ii) contacting said composition with said volume of the aqueous phase or with said surface before or after mixing said components A and B; wherein the weight ratio of NaBr and NaOCl in mixed components is about 1.5:1. In one embodiment of the invention, the weight concentrations of the reactants present in the final mixture, urea/NaBr/NaOCl/NaOH, can be approximately expressed as follows: 1.5/1.5/1/1. The word “approximately” in this context means within plus/minus 20%, and preferably within plus/minus 10%; for example, urea/NaOCl are in one embodiment from 1.2:1 to 1.8:1, preferably from 1.65:1 to 1.35:1.

### DETAILED DESCRIPTION OF THE INVENTION

It has now been found that stabilized, bromine-containing biocidal and antifouling compositions can be prepared from a bromide source and an oxidizer in higher yield when said bromide source is premixed with an at least molar amount of urea and said oxidizer with an at least molar amount of alkaline hydroxide. In typical examples, the final biocidal and antifouling mixtures contained at least twice as much active halogen, measured by iodometric titration, when the oxidizer was “boosted” with sodium hydroxide. For example, when mixing sodium bromide with commercial sodium hypochlorite, the total active halogen in the mixture decreased after the reaction due to the decomposition of hypohalite species to halides, the losses being typically between 70-80%, the yield being merely 20-30%. The losses were lowered below 25%, and the yield to 75%, when a boosted hypochlorite solution was used for oxidizing a bromide source. When incorporating urea into the bromide source, the active halogen in the final mixture was more stable. An improved method for removing or preventing biofouling in aqueous systems was developed, including employing bromide source boosted with urea and oxidizer boosted with hydroxide. For example, a simple two component composition was employed, comprising component A consisting of an aqueous solution of NaBr and urea in a weight ratio of about 1:1, and component B consisting of an aqueous solution of NaOCl and NaOH in a weight ratio of about 1:1; said components A and B were combined so that the weight ratio of urea/NaOH was about 1.5. For example, components A and B were mixed in equal volumes when they had the same molar concentrations of bromide and hypochlorite.

The method of the invention provide biocidal and antifouling compositions more efficiently and economically than known methods, whereas the produced compositions are stable during storage, and when applied they have persistent killing effect and prevent the development of biofilms on the treated surfaces.

In a preferred embodiment, the method of the invention comprises contacting the treated volume or surface with two liquid streams, one of which comprises an aqueous solution of bromide source boosted with urea, and the other a commercial oxidizer, such as alkali sodium hypochlorite, boosted with hydroxide. The bromide source and the oxidizer are preferably in equimolar amounts. Preferably said urea is at least in an equimolar amount in regard to said bromide source, and said hydroxide is at least in an equimolar amount in regard to said oxidizer. More preferably, both urea and hydroxide are present in a molar excess over said bromide and oxidizer, respectively; for example, said excess is between 1.5 and 2.0 mol per mol.

The method enables simple and safe handling of reagents. Advantageously, only two components, as a kit, are stored to be mixed before use, one comprising the bromine source boosted with urea, and the other hypochlorite boosted with hydroxide. Both components are stable on prolonged storage; moreover, even after combining said two components, the resulting active bromine solution is also relatively stable due to the presence of urea. Preferably, said two components are transported to the site of use and applied, possibly after diluting. In many applications, even concentrations as low as 0.1 ppm active bromine will be efficient, so that stock solutions may be diluted in situ as much as one to million. Stock solutions may comprise, for example, NaOCl of up to 7.5% (as chlorine). When using “%” in relation to concentrations, weight % (wt %) is intended. In the most preferred embodiment of the invention, an aqueous system is disinfected or treated against biofouling by a two component composition, whereas the components are safely brought to the site of application and combined; one of the component comprises an oxidant and the other a bromide source with urea. The components are boosted with a hydroxide of alkali metal. In a preferred embodiment of the invention, said hydroxide is premixed with said oxidant. The hydroxide may be premixed with said bromide and urea. The active bromine species are formed from said oxidant and said bromide on the site with a high efficiency and yield. Usually, the active bromine species are formed when two liquid streams are combined, one containing said oxidant and one said bromide and urea.

Bromide sources may include NaBr, KBr, NH₄Br, and urea hydrobromide. The “boosting” component for the bromide source is preferably urea, but biuret or polyurea may be employed. The oxidizer may comprise NaOCl, LiOCl, Ca(OCl)₂, chlorinated isocyanurates, urea hydroperoxide, hydrogen peroxide, percarbonates, perborates, peracetates or peroxycarboxylic acids, and persulfates; a preferred oxidizer comprises sodium hypochlorite. The boosting hydroxide may include sodium or potassium hydroxide.

Antifouling composition of the invention is effective even after diluting to a low concentration, down to several ppm of active bromine, or less. Concentrated stock solutions can be used for prolonged storage at ambient temperatures and than diluted to desired working concentrations. When using aqueous NaBr as the bromide source, solutions of up to 15 wt % are usually employed. When using NaOCl as the oxidizer, solutions of up to about 15% (as active chlorine) are usually employed. Component A may comprise NaBr and the same weight of urea, component B may comprise NaOCl and the same weight of NaOH. Components are mixed in equimolar amounts of bromide/oxidizer. The NaOCl concentration (as active chlorine) may be, for example about 10%, but between 0.5 wt % and 6 wt % is often useful. In a preferred process according to the invention, active halogen is preferably present in the aqueous composition in a concentration of from about 0.1 to about 20 wt % of chlorine or bromine, more preferably up to about 10 wt % of chlorine or bromine (calculated as total chlorine), for example 8 wt %, or 6 wt %, or 5 wt %, or 4 wt %, or 3 wt %, or 2 wt %. Halogen may have, for example, a concentration of from 1 to 5 wt % (initially corresponding to active chlorine), and active bromine recovery may be between 50 and 80% (mol of active bromine per mol of initial active chlorine). A desired nominal active halogen concentration, according to the intended application of said aqueous composition, may comprise values selected from the group consisting of 0.0001 wt %, 0.001 wt %, 0.01 wt %, 0.1 wt %, 0.2 wt %, 0.3 wt %, 0.4 wt %, 0.5 wt %, 0.6 wt %, 0.75 wt %, 1.0 wt %, 1.5 wt %, 2 wt %, 2.5 wt %, 3.0 wt %, up to 4 wt %, and up to 10 wt %. Practical working solutions may, for example, comprise a bromine concentration, calculated as available chlorine, according to the desired use, of about 0.5 ppm. In other applications, said concentration may be selected from the group consisting of 1 ppm, 2 ppm, 3 ppm, 5 ppm, 10 ppm, 20 ppm, 30 ppm, and 50 ppm as available chlorine or as active chlorine. Other applications may require higher concentrations. For prolonged storage, and later use according to the invention, it is advantageous to utilize more concentrated aqueous solutions (for example up to 1-4%), which are surprisingly stable on storage even if being concentrated.

Biofouling is an undesired accumulation of organisms, such as animals or plants or fungi or bacteria, or their products or products of their decomposition in liquid volumes or on wet surfaces. Biofouling often comprises microorganisms, such as bacteria, fungi, algae, etc., and is called microfouling. Biofouling is found in almost all circumstances where water based liquids are in contact with other materials. Examples of afflicted surfaces include membranes, pipelines, and other industrial and agricultural equipments. Bio-fouling may be controlled by including biocides, by surface coatings, etc. The terms “antifouling process”, as used herein, is a process of removing the accumulation or preventing the accumulation of the said organisms, particularly microorganisms, or their products or products of their decomposition in aqueous liquid volumes or on surfaces in contact with aqueous liquids. The term “antifouling composition”, as used herein, denotes an aqueous solution comprising urea and halogen according to the present invention.

The invention is directed to a process of preventing or eliminating biofouling in industrial waters, like cooling towers, pulp and paper industry, production aqueous streams, effluent water, irrigation systems and agricultural applications, or the like, while efficiently utilizing the active chlorine sources and converting bromine source to active bromine. The waters may be treated in static containers or in dynamic streams. In one embodiment, the stream comprises production circuits in paper mill, for example comprising pulp slurry. The treatment may be applied in an effluent to be released from an industrial process. Generally, the method and the composition of the invention are useful in treating waters which are intermediate or terminal streams in industrial and agricultural processes. The aqueous mixtures to be treated according to the invention may, for example, comprise industrial waters selected from cooling water, water for agricultural use, water in paper mill process, or waste water.

The instant method enables to lower the volumes of reagents employed in anti-biofouling treatments. Both the volumes of reagents injected into the treated waters and the volumes of stock solutions are reduced, simplifying storage, transport and handling.

### EXAMPLES

### Example 1

### Molar Ratio Urea:NaBr:NaOCl:NaOH=2:1:1:1.56

Solution 1: Preparation of Basic NaOCl

To an aq. 3% NaOCl (42.3 mmol as Cl₂), which was prepared from 24.2 g of 12.4% NaOCl and 73.1 g water, solid NaOH was added (2.6 g, 66.2 mmol).

Solution 2: Preparation of NaBr and Urea solution (NaBr:Urea 1:2)

To Urea (5.08 g, 84.7 mmol) and NaBr (4.5 g, 43.7 mmol) was added H₂O (90.4 g).

Solution 1 was added during 37 min to solution 2 to produce an uncolored solution.

Iodometric Titration: 1.23% as Cl₂ (81.8% of that expected). pH 13.21.

Note: The result remains unchanged if the experiment is repeated in such a way that the NaOH excess is added to the urea+NaBr solution. However, it is advantageous, from the process and safety viewpoints, to handle the reagents as two components: “boosted bromide” and “boosted hypochlorite”.

### Example 2

### Molar Ratio Urea:NaBr:NaOCl:NaOH=2:1:1:0.158

Solution 1: Preparation of Basic NaOCl

To an aq. 3% NaOCl (42.3 mmol as Cl₂), which was prepared from 24.2 g of 12.4% NaOCl and 75.3 g water, solid NaOH was added (0.27 g, 6.7 mmol).

Solution 2: Preparation of NaBr and Urea solution (NaBr:urea 1:2) To Urea (5.08 g, Mw 60, 84.7 mmol) and NaBr (4.5 g, Mw 102.9, 43.7 mmol) was added H₂O (90.4 g)—

Solution 1 was added during 37 min to solution 2 to produce an uncolored solution.

Iodomtertic Titration: 0.35% as Cl₂ (23.3% of that expected). pH 6.76. The concentrations are in wt %.

### Example 3

### Molar Ratio Urea:NaBr:NaOCl:NaOH=2:1:1:0.02

Solution 1: Preparation of Basic NaOCl

To an aq. 3% NaOCl (42.3 mmol as Cl₂), which was prepared from 24.2 g of 12.4% NaOCl and 75 g water, solid NaOH was added (0.03 g, 0.7 mmol).

Solution 2: Preparation of NaBr and Urea solution (NaBr:urea 1:2)

To Urea (5.08 g, Mw 60, 84.7 mmol) and NaBr (4.5 g, Mw 102.9, 43.7 mmol) was added H₂O (90.4 g).

Solution 1 was added during 37 min to solution 2 to produce an uncolored solution.

Iodometric Titration: 0.41% as Cl₂ (26% of that expected). pH 6.4.

### Example 4

### Molar Ratio=Urea:NaBr:NaOCl:NaOH 2:1:1:1

Solution 1: Preparation of Basic NaOCl

To an aq. 3% NaOCl (42.3 mmol as Cl₂), which was prepared from 24.2 g of 12.4% NaOCl and 73.9 g water, solid NaOH was added (1.7 g, 42.5 mmol.

Solution 2: Preparation of NaBr and Urea solution (NaBr:urea 1:2)

To Urea (5.08 g, Mw 60, 84.7 mmol) and NaBr (4.5 g, Mw 102.9, 43.7 mmol) was added H₂O (90.4 g).

Solution 1 was added during 37 min to solution 2 to produce an uncolored solution.

Iodomtertic Titration: 1.04% as Cl₂ (69% of that expected). pH 13.2.

### Example 5

### Molar Ratio=Urea:NaBr:NaOCl:NaOH 3:1:1:1.56

Solution 1: Preparation of Basic NaOCl

To an aq. 3% NaOCl (42.3 mmol as Cl₂), which was prepared from 25 g of 12% NaOCl and 72.3 g water, solid NaOH was added (2.7 g, 67.5 mmol.

Solution 2: Preparation of NaBr and Urea solution (NaBr:urea 1:3)

To Urea (7.62 g, Mw 60, 127 mmol) and NaBr (4.5 g, Mw 102.9, 43.7 mmol) was added H₂O (87.9 g).

Solution 1 was added during 48 min to solution 2 to produce an uncolored solution.

Iodometric Titration: After 9 min 1.17% as Cl₂ 77.8% of that expected. pH 13.57.

### Example 6

### Molar Ratio=Urea:NaBr:NaOCl 3:1:1

Solution 1: Aq. 12.7% NaOCl (as active Cl₂; 23.7 g, 42.39 mmol)

Solution 2: Preparation of NaBr and Urea solution (NaBr:urea 1:3)

To Urea (7.6 g, Mw 60, 127 mmol) and NaBr (4.35 g, Mw 102.9, 42.3 mmol) was added H₂O (88 g), pH 8.62

Solution 2 was added to H₂O (475 g), then solution 1 was added during 31 min to produce an uncolored solution.

Iodometric Titration: 0.16% as Cl₂ 31.8% of that expected. pH 7.3 UV: 275 nm

### Example 7

### Molar Ratio=Urea:NaBr:NaOCl 3:1:1

Solution 1: Aq. 12.7% NaOCl (as active Cl₂; 23.7 g, 42.4 mmol)

Solution 2: Preparation of NaBr and Urea solution (NaBr:urea 1:3)

To Urea (7.62 g, Mw 60, 127 mmol) and NaBr (4.35 g, Mw 102.9, 42.3 mmol) was added H₂O (88 g), pH 8.32

Solution 1 was added to H₂O (475 g), then solution 2 was added during 33 min to produce an uncolored solution.

Iodometric Titration: 0.17% as Cl₂ 33.8% of that expected. pH 7.3

UV: 274 nm.

### Example 8

### Molar Ratio=Urea:NaBr:NaOCl 3:1:1

Solution 1: Aq. 12.7% NaOCl (as active Cl₂; 23.7 g, 42.4 mmol)

Solution 2: Preparation of NaBr and Urea solution (NaBr:urea 1:3)

To Urea (7.62 g, Mw 60, 127 mmol) and NaBr (4.35 g, Mw 102.9, 42.3 mmol) was added H₂O (88 g).

Solution 1 and solution 2 were added in parallel during 10 min to H₂O (475 g) to produce an uncolored solution.

Iodometric Titration: 0.19% as Cl₂ 37.79% of that expected. pH 7.3 UV: 274 nm.

### Example 9

### Biocidal Activity Against Simulated Biofilm Systems (Alginate Beads)

A biofilm simulation system, alginate beads, developed by the Biofilm Bozeman Institute Montana (Grobe, K. J, Zahller, J and Stewart P. S., 2002 in “Role of dose concentration in biocide efficacy against Pseudomonas aeruginosa Biofilms”, J. Industrial Microbiology & Biotechnology, vol. 29, pp 10-15), was used in order to evaluate the efficacy of the biocide solution against biofilm.

### Preparation of the Alginate Beads

The biofilm simulation was created by entrapping bacteria in alginate gel beads. A plate of R2A agar was streaked with Pseudomonas aeruginosa (ATCC 15442) and incubated at 35° C. overnight. Buffer phosphate at pH 7.2 was used to scrap off the bacteria from the agar plate and to create a suspension. The bacterial suspension was mixed with an equal volume of an aqueous 4% sodium alginate solution, to make a final 2% alginate solution. The alginate and bacterial slurry were placed in a 50 ml syringe attached to a gauge needle, connected to a compressed air tank, allowing the syringe to be pressurized. At 20 psig pressure a stream of small drops was forced out and dropped into a stirred solution of 50 mM CaCl₂. The Ca⁺² cross linked the alginate, and semi solid beads with entrapped bacterial cells were formed. The beads were allowed to stir in the CaCl₂ solution for about 20 minutes, and then rinsed in a dilute 5 mM CaCl₂ solution. Several flasks containing 100 beads each were incubated overnight at 35° C. on a rotating shaker in a buffer solution (at pH 8) with 5 mM addition of CaCl₂ to maintain the beads structure. The resulting beads diameter was about 2 mm.

### Measuring Biocidal and Antifouling Efficacy

At the beginning of the experiment, the supernatant of the beads buffer suspension containing 5 mM CaCl2 was decanted and replaced by the 100 ml biocide solution with the required concentration (at pH 8). After different interval contact times, 10 beads were removed and placed in a 5 g/l sodium thiosulfate solution containing 50 mM sodium citrate. The sodium citrate was used to dissolve the alginate gel and release the bacteria into the solution. The neutralizer-citrate solution was placed in the refrigerator for 2 hours, than diluted and placed on R2A agar plates using pour plate technique. The plates were incubated at 35° C. for 24-48 hours and counted. The efficacy and toxicity of the neutralizer were checked as well as a control experiment without biocide addition. Four concentrations of active chlorine (0.5, 1, 2.5 and 5 ppm) were tested at four different contact times (5, 15, 30, and 60 min). Table 1-2 describe the surviving colony forming units (CFU) of the bacteria after different biocides treatment at different contact times.

TABLE 1
Biocidal efficacy of bromourea (from Urea + NaBr + NaOH + NaOCl)
against bacterial beads - survival of bacteria (CFU) as a function
of biocide loading and contact time

| Contact time | Biocide concentration (ppm as Cl₂) | | | |
|---|---|---|---|---|
| (min) | 0.5 | 1 | 2.5 | 5 |
| 0 | 9.74E+06 | 9.74E+06 | 9.74E+06 | 9.74E+06 |
| 5 | 8.25E+06 | 5.55E+06 | 7.08E+06 | 1.31E+07 |
| 15 | 8.65E+06 | 1.13E+07 | 3.38E+06 | 1.70E+06 |
| 30 | 9.43E+06 | 2.56E+06 | 2.44E+05 | 8.85E+04 |
| 60 | 8.83E+06 | 6.85E+04 | 40.0 | 2.50 |

TABLE 2
Biocidal efficacy of NaOCl against bacterial beads - survival of
bacteria (CFU) as a function of biocide loading and contact time

| Contact time | Biocide concentration (ppm as Cl₂) | | | |
|---|---|---|---|---|
| (min) | 0.5 | 1 | 2.5 | 5 |
| 0 | 1.20E+07 | 1.20E+07 | 1.20E+07 | 1.20E+07 |
| 5 | 6.73E+06 | 7.25E+06 | 6.40E+06 | 4.55E+06 |
| 15 | 6.48E+06 | 4.18E+06 | 3.10E+06 | 7.03E+05 |
| 30 | 6.53E+06 | 4.28E+06 | 8.28E+05 | 2.70E+03 |
| 60 | 4.08E+06 | 1.81E+06 | 9.38E+04 | 1.00 |

### Measuring Biocidal Efficacy Under Different TOC Loading

Inoculum of bacteria (activated sludge taken from domestic waste water treatment plant in Haifa), R2A agar for general counting, and Tryptone were employed. The biocidal efficacy of the antifouling composition at different organic loads of 0, 10, 30 and 50 ppm TOC, was examined under different biocidal concentrations (5 and 10 ppm) at pH 7.

1) 1 ml of inoculum with the appropriate biocide concentration (5, 10 ppm) was added to tryptone solutions, 100 ml each, with different concentrations of TOC (0, 10, 30 and 50 ppm).
2) 1 ml of sample that did not contain any biocide was inoculated on R2A agar (pour plate method). The result stands for the bacteria count at zero time.
3) After 30 min. of shaking (100 rpm), 1 ml of each sample was transferred to a tube filled with 9 ml of the neutralization solution (NaHSO₄).

An aliquot of 1 ml was taken from this solution and added to another tube containing 9 ml of buffer solution. The solution was mixed under vortex. This operation was repeated for 4 more times.

4) 1 ml from the two lowest dilutions was inoculated on a R2A agar (by the pour plate method).
5) After the plates were incubated at 25° C. for 5-7 days, the bacteria count was recorded.

The results are presented in Tables 3 and 4.

TABLE 3
% kill of the biocide solution comprising
Urea + NaBr + NaOH + NaOCl at different TOC concentrations

| TOC conc. | 5 ppm | 10 ppm |
|---|---|---|
| 0 | 87.4 | 97.0 |
| 10 | 86.3 | 96.6 |
| 30 | 81.3 | 86.6 |
| 50 | 82.0 | 90.8 |

TABLE 4
% kill of NaOCl at different TOC concentrations

| TOC conc. | 5 ppm | 10 ppm |
|---|---|---|
| 0 | 96.9 | 99.9 |
| 10 | 86.0 | 98.8 |
| 30 | 30.6 | 95.4 |
| 50 | 30.6 | 88.3 |

### Example 10

### Biocidal Composition in Aqueous Streams

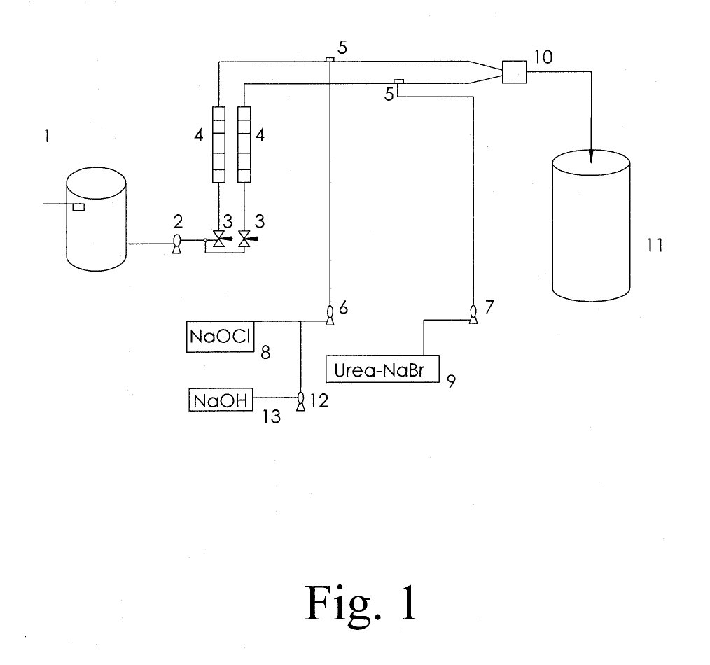

As outlined in FIG. 1, water was pumped from tank with float valve (1) by pump (2) through needle valves (3), rotameters (4), and injectors (5) to mixing cell (10). Aqueous NaOCl was pumped from storage tank (8) by pump (6). Aqueous sodium hydroxide was pumped from storage tank (13) by pump (12) through injector (5) to mixing cell (10). Aqueous mixture of urea and sodium bromide (Urea-NaBr) was pumped from storage tank (9) by pump (7) through injector (5) to mixing cell (10). A first stream after injectors (5), comprising NaOCl boosted with NaOH and mixed with water, was injected to the mixing cell; a second stream after injectors (5), comprising urea and NaBr mixed with water, was injected to the mixing cell; the two streams produced an uncolored solution (initially for example 5000 ppm as Cl2, to be further diluted with the treated water medium down to for example 5-10 ppm) ready to treat a surface or volume to be disinfected, for example the surface of waste tank (11) or any other object—and then be collected in said waste tank.

In one embodiment, the flow rates of the streams can be as follows: Water is pumped with a flow rate of about 50 kg/hr to each one of said injectors (5), 13.5% NaOCl solution is pumped with a flow rate of about 25 kg/hr to one of said injectors (5), 10% NaOH is pumped with a flow rate of about 25 kg/hr to one of said injectors (5), and aqueous mixture of about 10% urea and about 10% sodium bromide is pumped with a flow rate of about 50 kg/hr to one of said injectors (5). So that a first stream of an aqueous mixture of urea and bromide (component A) passes through one of injectors (5), and a second stream of an aqueous solution of oxidizer with NaOH (component B) passes through the other of said injectors (5), whereas both streams are mixed in mixing cell (10). Said NaOH ensures a pH more than 13.0 in the mixture of NaOH and NaOCl which enters injector (5). The weight ratios of the reactants present in the final mixture are roughly as follows (when including NaOH usually present in commercial NaOCl solutions, for example approximately 2 g NaOH per 10 g NaOCl):

urea/NaBr/NaOCl/NaOH=1.5/1.5/1/1

In other embodiments, storage tank (8) with NaOCl and/or storage tank (9) with Urea-NaBr comprise a part of NaOH which should be comprised in the final mixture and, therefore, less NaOH flows from storage tank (13) of NaOH. A skilled person will know how to adjust flow rates of the components to obtain desired final concentrations. In some embodiments, NaOH may flow directly to mixing cell (10), constituting a third stream to be mixed with the oxidizer stream and with the urea-bromide stream on the desired site where the biocidal and antifouling activity is needed.

### Example 11

In the same arrangement as shown in FIG. 1, a water stream was pumped (5 l/hr) from tank (1) and was divided to two equal lines comprising injectors (5). Aq. 10.8% NaOCl from tank (8) was pumped (1900 ml/hr) together with aq 50% NaOH from tank (13) by an additional pump (250 ml/hr) into one of the water stream. In parallel, a mixture of 41% urea and 35% NaBr from tank (9) was pumped (450 ml/hr) into the second water stream. The process provided the following molar ratio between the added reactants (without including NaOH present in the NaOCl solution):

urea/NaBr/NaOCl/NaOH=2:1:1:1.5.

While the invention has been described using some specific examples, many modifications and variations are possible. It is therefore understood that the invention is not intended to be limited in any way, other than by the scope of the appended claims.

1. A bromine-containing biocidal and antifouling aqueous composition, comprising component A and component B, wherein
i) component A is an aqueous solution consisting of a bromide source, and urea in a molar ratio to said bromide source of between 1 and 5; and
ii) component B is an aqueous solution consisting of an oxidizer essentially having the same molar concentration as said bromide source;
wherein said components A and B are either separate or mixed, and wherein said components provide a pH of at least 13.0 when combined.

2. A bromine-containing biocidal and antifouling aqueous composition, comprising component A and component B, wherein
i) component A is an aqueous solution consisting of a bromide source, and urea in a molar ratio to said bromide source of between 1.5 and 5, said solution having a pH of more than 6.0; and
ii) component B is an aqueous solution consisting of an oxidizer essentially having the same molar concentration as said bromide source, said solution having a pH of more than 13.0;
wherein said components A and B are either separate or mixed.

3. A bromine-containing biocidal and antifouling aqueous composition according to claim 1, wherein
i) said component A is an aqueous solution consisting of a bromide source selected from alkaline bromides, and urea in a molar ratio to said bromide source of between 1.8 and 3; and
ii) component B is an aqueous solution consisting of an oxidizer having essentially the same molar concentration as said bromide source, selected from NaOCl, LiOCl, Ca(OCl)₂, chlorinated isocyanurates, urea hydroperoxide, hydrogen peroxide, percarbonates, perborates, peracetates or peroxycarboxylic acids, and persulfates
said biocidal and antifouling composition comprising an alkali hydroxide in a molar ratio to said oxidizer of between 0.8 and 2.5, wherein said hydroxide is at least partially premixed with said component A and/or with said component B, or it is divided between components A and B, and wherein said components A and B are either separate or mixed.

4. A bromine-containing biocidal and antifouling aqueous composition according to claim 1, wherein
i) said component A is an aqueous solution consisting of sodium bromide (NaBr), and urea in a molar ratio to said sodium bromide of between 1.8 and 3;
ii) component B is an aqueous solution consisting of sodium hypochlorite (NaOCl) having essentially the same molar concentration as said sodium bromide, and sodium hydroxide (NaOH) in a molar ratio to said oxidizer of between 1 and 2.5.

5. A bromine-containing biocidal and antifouling aqueous composition according to claim 1, wherein said components A and B are separate and have essentially the same volumes, or they are mixed and exhibit a pH of at least 13.

6. A bromine-containing biocidal and antifouling aqueous composition according to claim 1, obtained by mixing component A and component B essentially having the same volumes, wherein
i) component A is an aqueous solution consisting of a bromide source, and urea in a molar ratio to said bromide source of between 1.5 and 5, said solution having a pH of more than 6.0; and
ii) component B is an aqueous solution consisting of an oxidizer essentially having the same molar concentration as said bromide source, said solution having a pH of more than 13.0; wherein the yield of active halogen after said mixing is at least 70% relatively to the initial amount of the oxidizer, when measured by iodometric titration.

7. A bromine-containing biocidal and antifouling aqueous composition according to claim 3, wherein said components A and B form two liquid streams, or said components A and B and an aqueous solution of said alkali hydroxide form three liquid streams, said streams to be combined near the site to be disinfected.

8. A bromine-containing biocidal and antifouling aqueous composition according to claim 1, comprising component A and component B, wherein
i) component A is an aqueous solution consisting of NaBr, and urea in a molar ratio to said bromide source of between 1.5 and 2;
ii) component B is an aqueous solution consisting of NaOCl having essentially the same molar concentration as said NaBr, and NaOH either separate or admixed with said NaOCl in a molar ratio to said NaOCl of between 1.5 and 2.5;
wherein said components A and B have the same volumes and are either separate or mixed.

9. A bromine-containing biocidal and antifouling aqueous composition according to claim 8, for use in water disinfection, and in removing or preventing biofouling either in a volume of an aqueous phase or on a surface in contact with an aqueous phase, wherein said components A and component B are combined and then either mixed with said volume of an aqueous phase or contacted with said surface.

10. The composition of claim 8, being either a two-component composition comprising component A and component B, or a three-component system comprising said components A and B, and further said NaOH in aqueous solution, wherein said components are transported near to the site where said biofouling is to be prevented or removed, and then the components are applied either before diluting with water or after.

11. A kit for removing or preventing biofouling either in a volume of an aqueous phase or on a surface in contact with an aqueous phase, comprising the composition of claim 10.

12. A process of removing or preventing biofouling in a volume of an aqueous phase or on a surface in contact with an aqueous phase, comprising
i) providing the bromine-containing biocidal and antifouling aqueous composition of claim 3 comprising said components A and B, and said hydroxide; and
ii) contacting said liquid phase or said surface with said composition.

13. A process according to claim 12, comprising
i) optionally diluting one or both of said components A and B with water; and
ii) forming either two liquid streams comprising said components A and B, or three liquid streams comprising said component A, said component B, and said hydroxide, respectively, and
iii) combining said streams near said volume of a liquid phase or near said surface, or in said volume or on said surface.

14. A process according to claim 12, comprising
i) mixing said components A and B;
ii) optionally diluting one or both of said components A and B before said mixing of step i), or alternatively diluting the mixture of components A and B obtained in step i); and
iii) forming a liquid stream near said volume of a liquid phase or near said surface.

15. A process according to claim 12, wherein said aqueous phase or said surface comprises irrigation pipes, waste water, industrial cooling water, process water, equipment in the Pulp & Paper industry, packaging material, and food item such as meat.

16. A process according to claim 12, wherein said biocidal and antifouling composition unclogs pierced irrigation pipes and fertilizes the irrigated plot.

17. A process according to claim 12, wherein said step of providing the biocidal and antifouling composition is a batch procedure or a continuous procedure.

18. A process according to claim 12, wherein said the bromine-containing biocidal and antifouling aqueous composition is diluted to an active bromine concentration of at least 0.1 ppm.

19. A process according to claim 12, comprising
i) providing a composition consisting of components A and component B, wherein component A contains aqueous urea and NaBr in a molar ratio of about 2:1, and component B contains aqueous NaOH and NaOCl in a molar ratio of about 2:1; and
ii) contacting said composition with said volume of the aqueous phase or with said surface before or after mixing said components A and B; wherein the molar ratio of NaBr and NaOCl in mixed components is about 1:1.
